(19) United States
(12) Patent Application Publication
(10) Pub. No.: US 2025/0266516 A1
(43) Pub. Date: Aug. 21, 2025

(54) BATTERY DISCHARGE SYSTEM FOR END-OF-LIFE PROTECTION

(71) Applicant: GE Precision Healthcare LLC, Waukesha, WI (US)

(72) Inventors: Scott Edward Wendling, Waukesha, WI (US); Jonathan James Ryan, Waukesha, WI (US)

(73) Assignee: GE Precision Healthcare LLC, Waukesha, WI (US)

(21) Appl. No.: 18/443,421

(22) Filed: Feb. 16, 2024

(51) Int. Cl. H01M 10/44; H01M 10/42; H01M 10/48; H01M 50/583

(52) U.S. Cl. CPC H01M 10/44; H01M 10/425; H01M 10/488; H01M 50/583; H01M 2010/4271

(57) ABSTRACT

A system and method for discharging the battery cells of a battery pack for rendering the battery pack safe for shipping and disposal and preventing further use of the battery pack after reaching an end of life state. A discharge switching device is included in the battery pack and is configured to permanently transition from a first state to a second state. When the discharge switching device transitions to the second state, the stored voltage in the battery cells discharges through a voltage drain circuit that includes a power consuming load and a drain circuit. The transition of the discharge switching device to the second state prevents further charging of the battery cells in the battery pack. The transition of the discharge switching device can be controlled by a manual activation device and/or a battery management system of the battery pack.

### BACKGROUND

The present disclosure generally relates to a battery discharge system for removing the charge on a battery pack for safe shipping and disposal. More specifically, the present disclosure relates to a battery discharge system that discharges a stored charge on the battery cells of a battery pack and prevents further charging of the battery cells so that the battery pack can no longer be used and can be safely shipped and disposed.

The increased use of battery powered devices across many fields of use, including in a hospital or healthcare environment, has resulted in an ever-increasing number of battery packs that must be disposed of after the useful life of the battery pack has ended. In some cases, battery packs that reach their end of life are shipped back to the battery or device manufacturer so that the battery or device manufacturer can study and analyze data that is stored on the battery management system (BMS) for the battery pack.

In other cases, when a battery pack becomes faulty or unstable, the defective battery pack is returned to either the device manufacturer or the battery pack manufacturer for study and investigation. Although field-based representatives for the device manufacturer may be able to pick up the faulty or expired battery packs and return the battery packs to a facility for analysis, it would be much more convenient for the battery packs to be shipped using commercial shipping companies.

Many commercial shipping companies will not accept battery packs for shipment, especially lithium-ion battery packs, based on the potential fire hazard these batteries present when there is a stored charge in the battery cells of the battery pack. Since commercial shipping companies will not accept the battery packs for shipment, the inventors of the present disclosure identified a need for a system to fully discharge the battery pack prior to shipment and possible disposal. Further, the inventors have identified a need for a battery pack that includes a system to not only discharge the battery pack but also prevent any further charging and present a visual indication of such action such that the battery pack will be accepted for shipment.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In one embodiment, a system is provided that is able to discharge the battery cells of a battery pack to make the battery pack safe for shipping and disposal while also preventing further charging and discharging of the battery pack. The system in accordance with an exemplary embodiment of the present disclosure includes an activation device that is used to trigger the discharge of the battery cells in the battery pack prior to shipment and to render the battery pack incapable of retaining a charge. In an exemplary embodiment of the present disclosure, the activation device can include a manually operated engagement device and the battery management system of the battery pack. In other embodiments, the manually operated engagement device can be eliminated and the battery management system would trigger the discharge of the battery cells.

The system further includes a discharge switching device that is operable to permanently transition from a first state to a second state. The transition from the first state to the second state is controlled and triggered by the activation device. In an exemplary embodiment, the discharge switching device is a chemical fuse that permanently transitions from a first state (closed) to a second state (open).

A voltage drain circuit is connected to the positive end of the battery cells and provides a discharge path for the stored voltage on the battery cells when the voltage drain circuit is in an operational state. In an exemplary embodiment, the voltage drain circuit include both a power consuming load and drain switching device, such as a MOSFET. When the drain switching device is closed, the battery cells are able to discharge through the power consuming load. When the drain switching device is open, the power consuming load is connected to an open circuit and the stored voltage on the battery cells cannot discharge through the power consuming load.

When the discharge switching device transitions to the second state, the discharge switching device allows the voltage drain circuit to provide a discharge path for the voltage on the battery cells. In this state, the voltage on the battery cells is nearly completely discharged so that the battery pack can be safely shipped and/or disposed. Further, when the discharge switching device is in the second state, the discharge path from the battery cells remains and the battery cells can no longer be charged. Thus, in an end of life state of the battery pack, the internal components of the battery pack, including the discharge switching device, prevents any further use of the battery pack.

Various other features, objects, and advantages of the invention will be made apparent from the following description taken together with the drawings.

### BRIEF DESCRIPTION OF THE DRAWINGS

The present disclosure is described with reference to the following Figures.

FIG. 1 is a circuit schematic diagram showing the system of the present disclosure to discharge the cells of a battery pack and disable charging;

FIG. 2 is a simplified circuit schematic showing the switching device in a first, closed state;

FIG. 3 is a simplified circuit schematic showing the switching device in a second, open state; and

FIG. 4 is a flow chart showing one exemplary method for operating the system of the present disclosure to render a battery pack ready for shipping.

### DETAILED DESCRIPTION

The present inventors have recognized several problems with currently available battery management circuits for lithium-ion battery packs that are unable to fully ensure that the battery packs are protected from end user abuse. If a battery pack is used longer than the expected life of the battery, the battery pack may become unstable and could possibly cause damage. In addition, at the end of life of the battery pack, the present inventors have recognized a problem in not being able to fully discharge the battery cells so that the battery pack can be safely shipped. The present disclosure was developed by the inventors to completely disable the further use of the battery pack and to discharge the battery cells to a level that allows for safe shipping.

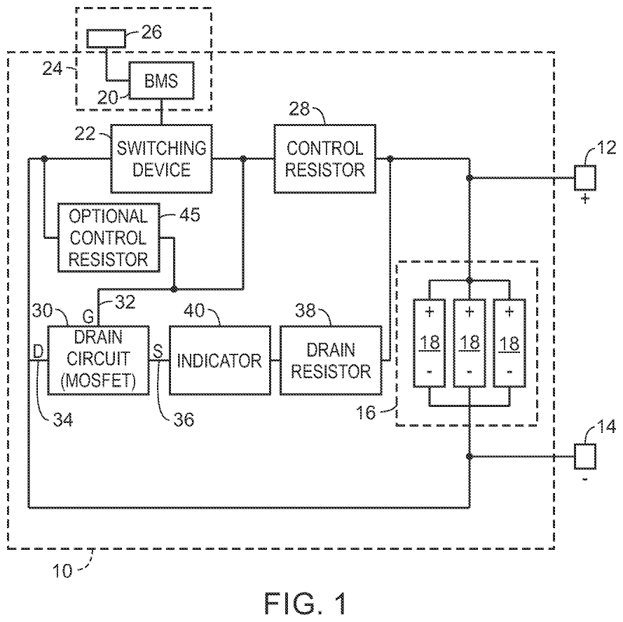

FIG. 1 illustrates a battery pack 10 constructed in accordance with the present disclosure. The battery pack 10 is designed as a self-contained unit that includes an enclosed housing and can be used to power a wide variety of equipment, such as but not limited to medical equipment. The battery pack 10 shown in FIG. 1 includes a pair of external contact terminals 12, 14 that provide electrical connections for operating battery-powered equipment in a standard fashion. Although only two contact terminals 12, 14 are shown in the embodiment of FIG. 1, it should be understood that the battery pack 10 could include additional terminals depending upon the configuration of the battery pack 10 and the potential uses of the battery pack 10.

In the embodiment shown, the battery pack 10 includes a battery cell block 16 that is connected between the positive contact terminal 12 and the negative contact terminal 14. In the embodiment shown, the battery cell block 16 includes a combination of individual battery cells 18 that are connected to each other to provide the available current and voltage for the battery pack 10. In the embodiment shown, the battery cell block 16 includes three individual battery cells 18 that are connected in a parallel relationship. Although the individual battery cells 18 are shown in FIG. 1 as connected in parallel and including three separate cells 18, it should be understood that the number of individual battery cells 18 and the connections between the battery cells 18 can vary depending upon the individual battery pack 10. As an example, the battery cell block 16 could be a single battery cell 18 or could include multiple battery cells 18. In an embodiment with multiple battery cells 18, the battery cells 18 can be connected in series and/or parallel depending on the voltage and current requirements for the resulting battery pack 10.

As is well known in battery pack management, the battery pack 10 includes a battery management system (BMS) 20 that is included in the outer housing for the battery pack 10 and operates to control the charging and discharging of the battery cell block 16. In addition to controlling the charging and discharging of the battery cell block 16, the BMS 20 also monitors the operation of the entire battery pack 10 and provides a point of communication between the equipment being operated and the battery pack 10. The BMS 20 is a conventional integrated circuit that is readily available from a wide variety of different manufacturers, such as but not limited to Texas Instruments and Micron. The BMS 20 includes an integrated circuit that monitors the charging, discharging and operational parameters associated with the operation of the entire battery pack 10.

In the embodiment shown, the battery cell block 16 includes a series of lithium-ion battery cells 18 that can be repeatedly charged and discharged to provide for a standard lifecycle for the entire battery pack 10. The BMS 20 monitors the charging and discharging life of the battery cell block 16 and will disable further use of the battery pack when the battery pack reaches defined end of life parameters, which can be number of charging cycles, time in use or other specific parameters.

According to standard UL and IEC safety requirements, the BMS 20 operates to disable future charging or discharging cycles when the battery pack reaches an end-of-life (EOL) condition. Although the BMS 20 includes electronics that are designed to prevent future charging and discharging cycles of the battery cell block 16, the BMS 20 is unable to ensure that the battery pack is protected from end user abuse, such as overriding the controls of the BMS 20 to continue to use the battery pack after the end of life as dictated by the battery manufacturer. In addition to preventing the charging and discharging of the battery cell block 16 due to end-of-life parameters, the BMS 20 can also prevent continued use of the battery pack 10 upon failure parameters and extreme fault conditions. Once again, although the BMS 20 includes programing and operating instructions to prevent use after reaching the end of life triggers, there is a possibility of end user abuse and thus overriding the operation of the BMS 20 during these fault conditions.

Therefore, the inventors of the present disclosure have identified a need to completely disable the use of the battery pack while also discharging any stored charge on the battery cell block 16 so that the battery pack 10 can be transported and shipped back to a manufacturer to recycle or investigate the cause of a defect that resulted in the BMS 20 preventing further use of the battery pack 10.

In the embodiment shown in FIG. 1, a discharge switching device 22 is added to the internal circuitry for the battery pack 10. The discharge switching device 22 is shown in the embodiment of FIG. 1 as being controlled by an activation device 24. The activation device 24 shown in the embodiment of FIG. 1 includes both the BMS 20 and a manually operated engagement device 26. The manually operated engagement device 26 could be any type of device that can be engaged and operated by a user, such as but not limited to a push button, manually operated switch or other component. When a user operates the engagement device 26, the engagement device 26 sends a signal or other type of indication to the BMS 20 such that the BMS 20 can trigger the operation of the discharge switching device 22. In other embodiments, the engagement device 26 can be connected directly to the discharge switching device 22 without the need for the BMS 20 to generate an activation signal to control the operation of the discharge switching device 22. In another alternate embodiment, the engagement device 26 can be eliminated and the triggering signal to the BMS 20 can be generated in other ways, such as by a wired or wireless signal delivered to the BMS 20, such as through the connection between the equipment being powered by the battery pack 10 or an external communication device that communicates with the BMS 20. In any case, the BMS 20 or the engagement device 26 deliver a triggering signal to the discharge switching device 22 to cause the discharge switching device 22 to change states.

In one exemplary embodiment of the present disclosure, the discharge switching device 22 is a chemical fuse that operates to permanently transition from a first state to a second state. The chemical fuse that can be utilized as the discharge switching device makes a permanent transition from the first state to the second state such that the state of the discharge switching device cannot be reversed. Although a chemical fuse is contemplated as being an exemplary embodiment of the discharge switching device 22, it should be understood that different types of switching devices that permanently transition from a first state to a second state could be utilized while operating within the scope of the present disclosure. The permanent transition of the discharge switching device 22 from a first state to a second state prevents end user abuse since the discharge switching device cannot be overridden after the permanent transition from the first state to the second state.

As further shown in FIG. 1, a control resistor 28 is shown positioned between the positive end 42 of the battery cell block 16 and the discharge switching device 22. The resistance value of the control resistor 28 is selected to create the required voltage across the control resistor 28 as will be discussed in further detail below.

The internal circuitry of the battery pack 10 further includes a voltage drain circuit 30 that includes one of its terminals connected to a junction point between the control resistor 28 and the discharge switching device 22. The voltage drain circuit 30 in the exemplary embodiment illustrated is a MOSFET that has the gate terminal 32 connected to one end of the control resistor 28 and the drain terminal 34 connected to a ground potential. The source terminal 36 of the MOSFET is connected to the positive terminal of the battery cell block 16 through a drain resistor 38. Although a drain resistor 38 is shown in the embodiment, it should be understood that other different types of power consuming loads could be used in place of the drain resistor 38 while operating within the scope of the present disclosure.

In the exemplary embodiment illustrated, a visual indicator 40 is also located between the drain resistor 38 and the source terminal 36 of the MOSFET voltage drain circuit 30. The indicator 40 is selected to be some type of phase change material that changes the state upon the application of current or voltage. The indicator 40 is located within the batter pack 10 such that the indicator is visible through the housing of the battery pack 10. The indicator 40 is included in the battery pack to indicate to an end user that the discharge switching device 22 has been activated and the stored charge contained on the battery cell block 16 has been discharged, thereby indicating that the battery pack 10 is safe for shipment. The indicator 40 can be eliminated in other embodiments of the present disclosure, but it is desired to include some type of indication that the battery cell block 16 has been discharged to a safe level that allows for shipment of the battery pack 10.

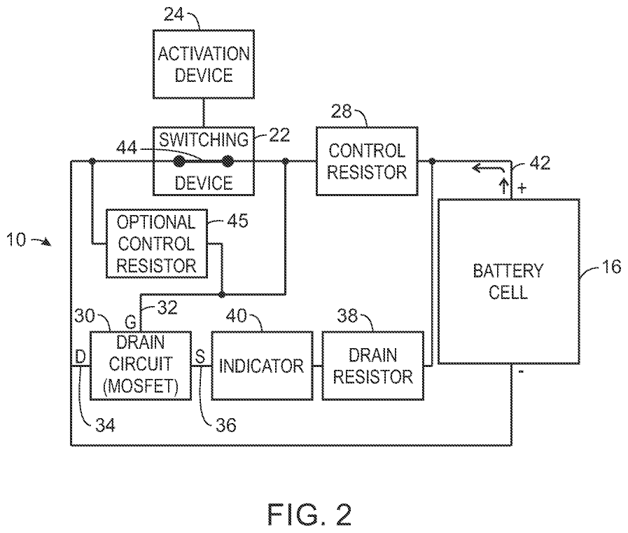

FIG. 2 is a simplified version of the circuitry shown in FIG. 1 and illustrates the operation of the internal circuitry within the battery pack 10 in a condition in which the discharge switching device 22 is in a first state. In the embodiment shown in FIG. 2, the discharge switching device 22 is shown as a closed switch 44. In an embodiment in which the discharge switching device 22 is a chemical fuse, the closed switch provides a direct path for current to flow through the discharge switching device. In this first state, the positive side 42 of the battery cell block 16 is connected to the control resistor 28. In this configuration, the gate terminal 32 of the MOSFET voltage drain circuit 30 is directly connected to the drain terminal 34 through the discharge switching device 22 such that no voltage differential is established between the gate terminal 32 and the drain terminal 34. In this condition, the voltage drain circuit 30 functions as an open switch and the battery cell block 16 will not be able to discharge through the drain resistor 38. Thus, during normal operating conditions, the discharge switching device 22 is in the first state in which the switch element 44 is closed. Thus, during normal operating conditions, the additional circuitry added to the battery pack 10 allows the battery pack to operate in a normal manner and allows the battery management system 20 shown in FIG. 1 to control the discharge and charging of the battery cell block 16.

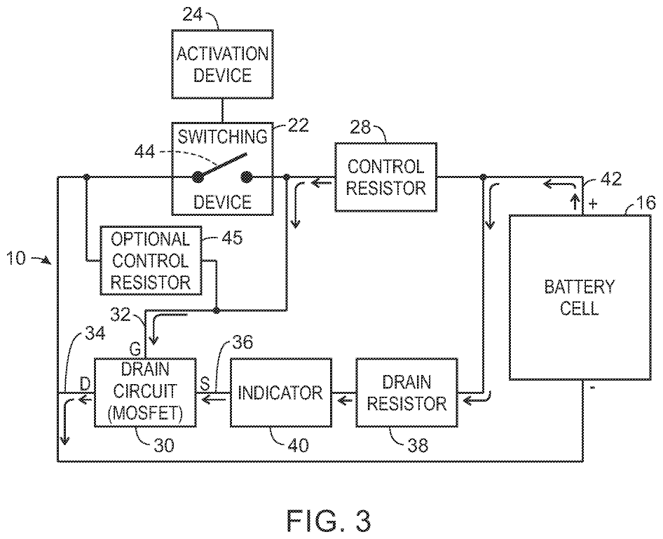

When an end user or the BMS 20 identifies a desire or operating parameter that indicates the need to move the battery pack 10 to an end of life state, the end user can either activate the engagement device 26 or the BMS 20 will automatically initiate the end-of-life transition. During the end-of-life transition, the activation device 24 sends an activation signal to the discharge switching device 22 which causes the discharge switching device 22 to permanently transition from the first state (closed) to the second state (open) shown in FIG. 3. In the second state shown, the switch element 44 moves or transitions to an open position. In the example in which the discharge switching device 22 is a chemical fuse, the chemical fuse opens and creates an open circuit as illustrated in FIG. 3.

When the discharge switching device 22 transitions to the second state and presents an open circuit, the positive side 42 of the battery cell block 16 is provided with a current flow path through the control resistor 28. The control resistor 28 is selected such that a gate voltage is created at the gate terminal 32 of the voltage drain circuit 30. The size of the control resistor 28 is selected such that the developed voltage at the gate terminal 32 is sufficient such that the voltage drain circuit 30 (which is a MOSFET in the embodiment illustrated) acts as a closed circuit path that allows current to flow from the source terminal 36 to the drain terminal 34. When the voltage drain circuit 30 is in this closed state, current flows through the drain resistor 38 and through the voltage drain circuit 30 to the ground potential. The drain resistor 38 is selected such that the drain resistor 38 consumes power from the battery cell block 16. As discussed above, although one or more drain resistors 38 are shown in the exemplary embodiment, it is contemplated that other types of power consuming loads could be used in place of the drain resistor 38 shown in the Figures. In this way, the drain resistor 38 will continue to discharge the battery cell block 16 until the voltage at the positive side 42 is no longer sufficient to provide enough current through the control resistor 28 to keep the voltage drain circuit 30 active. In an embodiment in which the voltage drain circuit 30 is a MOSFET, the voltage at the gate terminal 32 must be above a specified level to keep the MOSFET operating as a closed circuit. The level of voltage on the battery cell block 16 when the control resistor 28 is no longer able to provide a large enough voltage at the gate terminal 32 is a level low enough to allow the entire battery pack 10 to be shipped. As an example, the battery cell block 16 will be discharged to a voltage level in the range of 0.7 to 2.0 volts (depending on the setting with the optional control resistor 45 to keep the cells over the MOSFET dropout voltage) before the voltage at the gate terminal 32 is too low to prevent any further discharge of the battery cell. This voltage is sufficiently low to allow the entire battery pack 10 to be shipped.

During the discharge of the battery cell block 16 through the drain resistor 38, the indicator 40 will also be activated. As indicated previously, the indicator 40 is a state changing device that changes color or appearance when a voltage is applied to the indicator 40. It is contemplated that the indicator 40 will change appearance and will not change the appearance back even when the battery cell block 16 is completely discharged. The indicator 40 thus provides a visual indication that the entire battery pack 10 has been discharged and is safe to be shipped and that the voltage on the battery cell block 16 is sufficiently low to be of any concern.

As indicated above, when the discharge switching device 22 is moved to the second state shown in FIG. 3, the positive side 42 of the battery cell block 16 is connected to ground potential through the drain resistor 38 and the voltage drain circuit 30. After the transition of the discharge switching device 22 to the second state, if the BMS 20 or any other circuitry is connected to attempt to re-charge the battery cell block 16, any charge being applied to the battery 16 will immediately discharge through the voltage drain circuit 30 and the drain resistor 38. In this manner, the permanent transition of the voltage drain circuit 30 will prevent the battery cell block 16 from ever holding a charge above the charge needed to turn on the voltage drain circuit 30 through the voltage applied at the gate terminal 32.

Although the voltage drain circuit 30 shown in the preferred embodiment is described and discussed as being a MOSFET, it should be understood that other types of discharge circuits 30 could be utilized while operating within the scope of the present disclosure. The voltage drain circuit 30 is triggered by the transition of the discharge switching device 22 from the first state to the second state. Any type of device could be used as the voltage drain circuit 30 as long as the discharge circuit is triggered by the movement of the discharge switching device from the first state to the second state. Likewise, the discharge switching device 22 could be other types of switching elements as long as the discharge switching device transitions from the first state to the second state and cannot return back to the first state once the initial transition has taken place. In this manner, the discharge switching device 22 permanently transitions from the first state to the second state and cannot transition back from the second state to the first state.

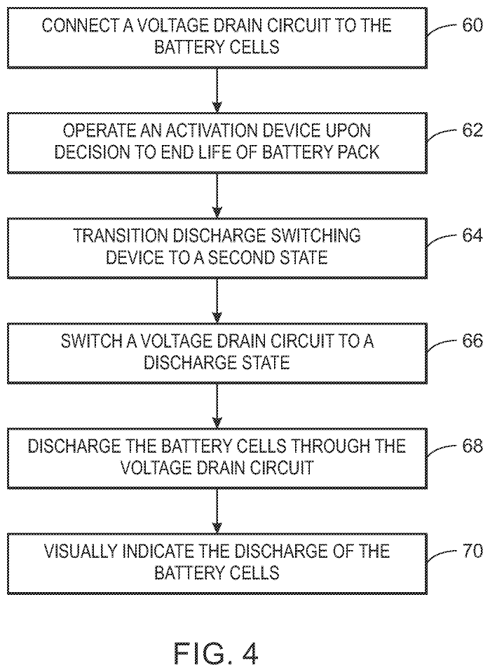

FIG. 4 is a flow chart showing and describing one exemplary method for operating the system of the present disclosure with the understanding that other embodiments are contemplated as being within the scope of the present disclosure. The reference numbers in the description refer to the components of FIGS. 1-3 previously described.

As shown in step 60, a voltage drain circuit 30 is included in the battery pack of the present disclosure. The voltage drain circuit 30 is connected to the positive terminal of the cell block 16 that includes the single or plurality of battery cells 18. The voltage drain circuit 30 is designed to selectively discharge the battery cells of the cell block so that the battery pack can be more safely shipped upon reaching an end-of-life condition or upon a fault condition.

Upon reaching an end-of-life or fault condition, an activation device of the battery pack is manually activated or automatically activates as shown in step 62. As described above, the activation device could be a manually operated device 26 or could be the battery monitoring system 20. The activation device is operated to trigger the discharge of the voltage and current stored in the battery cells 18 so that the battery pack can be safely shipped.

Once the activation device is triggered in step 62, the activation device causes a discharge switching device 22 to transition from a first steady state to a second state as shown by step 64. In an exemplary embodiment, the transition from the first state to the second state in step 64 is a permanent transition that cannot be reversed. Thus, once the discharge switching device 22 transitions to the second state, the discharge switching device 22 cannot return to the first state. In one contemplated embodiment, the discharge switching device is a chemical fuse that physically transitions to the second state. In the second state, the chemical fuse presents an open circuit although other types of switching devices are contemplated.

Upon transition of the discharge switching device to the second state, the voltage drain circuit 30 is switched into a discharge state, as shown in step 66. In the discharge state, the voltage drain circuit 30 connects the positive terminal of the battery cell block, and thus the battery cells in the battery cell block, to a discharge path. The discharge path can include a connection to a ground potential such that the stored voltage and current on the battery cells can be discharged to the ground potential. As described above, in one exemplary embodiment, the voltage drain circuit can include a switching device, such as a MOSFET, that can transition from an open state to a closed state.

In one contemplated embodiment, the voltage drain circuit can further include a drain resistor 38 positioned between the battery cell block and the switching device of the voltage drain circuit such that the voltage and current from the battery cells in the battery cell block are discharged through the drain resistor of the voltage drain circuit as shown by step 68. In an embodiment in which the voltage drain circuit includes a MOSFET, the voltage drain circuit is able to discharge the battery cells to the voltage level required to keep the MOSFET in the closed state. This voltage level is very small and upon complete discharge, the battery pack will be safe for shipment.

As shown in step 70, in one contemplated embodiment, a visual indicator can be activated to indicate that the battery cells of the battery pack have been discharged and that the battery pack is safe for shipment. The indicator 40 is a state changing device that changes color or appearance when a voltage is applied to the indicator 40. It is contemplated that the indicator 40 will change appearance and will not change the appearance back even when the battery cell block 16 is completely discharged. The indicator 40 thus provides a visual indication that the entire battery pack 10 has been discharged and is safe to be shipped and that the voltage on the battery cell block 16 is sufficiently low to be of any concern.

This written description uses examples to disclose the invention, including the best mode, and also to enable any person skilled in the art to make and use the invention. Certain terms have been used for brevity, clarity and understanding. No unnecessary limitations are to be inferred therefrom beyond the requirement of the prior art because such terms are used for descriptive purposes only and are intended to be broadly construed. The patentable scope of the invention is defined by the claims, and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

Unless otherwise specified or limited, the terms “mounted,” “connected,” “linked,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings. As used herein, unless otherwise limited or defined, discussion of particular directions is provided by example only, with regard to particular embodiments or relevant illustrations. For example, discussion of “top,” “bottom,” “front,” “back,” “left” or “right” features is generally intended as a description only of the orientation of such features relative to a reference frame of a particular example or illustration. Correspondingly, for example, a “top” feature may sometimes be disposed below a “bottom” feature (and so on), depending on the position of the element and the frame of reference. Additionally, use of the words “first,” “second”, “third,” etc. is not intended to connote priority or importance, but merely to distinguish one of several similar elements or machines from another.

We claim:

1. A system for rendering a battery pack safe for shipping or disposal, the system comprising:
a voltage drain circuit connected to battery cells of the battery pack;
a discharge switching device operable to transition from a first state to a second state, wherein the voltage drain circuit discharges the battery cells only when the discharge switching device is in the second state; and
an activation device operable to cause the discharge switching device to transition from the first state to the second state.

2. The system of claim 1 wherein the discharge switching device permanently transitions from the first state to the second state based on the activation device.

3. The system of claim 2 wherein the discharge switching device is a chemical fuse that can transition from the first state to the second state only one time.

4. The system of claim 1 wherein the activation device includes a manually operated engagement device.

5. The system of claim 1 further comprising a power consuming load that is connected to ground through the voltage drain circuit when the discharge switching device is in the second state.

6. The system of claim 1 wherein the activation device includes a battery management system included in the battery pack.

7. The system of claim 6 wherein the battery management system transitions the discharge switching device to the second state when the battery pack is in a severe fault condition.

8. The system of claim 6 wherein the activation device includes a manually operated engagement device that communicates with the battery management system.

9. The system of claim 1 further comprising a visual indicator operable to indicate the state of the discharge switching device.

10. A system for rendering a battery pack including battery cells safe for shipping or disposal, the system comprising:
a voltage drain circuit connected to a positive terminal of the battery cells;
a discharge switching device operable to permanently transition from a first state to a second state, wherein the voltage drain circuit discharges the battery cells when the discharge switching device permanently transitions from the first state to the second state; and
an activation device operable to cause the discharge switching device to transition from the first state to the second state.

11. The system of claim 10 wherein the discharge switching device prevents charging of the battery cells when the discharge switching device is in the second state.

12. The system of claim 11 wherein the discharge switching device is a chemical fuse.

13. The system of claim 10 wherein the activation device includes a manually operated engagement device.

14. The system of claim 10 further comprising a power consuming load that is connected to ground through the voltage drain circuit when the discharge switching device is in the second state.

15. The system of claim 10 further comprising a visual indicator operable to indicate the state of the discharge switching device.

16. A method of rendering a battery pack including battery cells safe for shipping or disposal, the method comprising the steps of:
operating an activation device upon a decision to discharge the battery cells;
transitioning a discharge switching device from a first state to a second state upon operation of the activation device, wherein the discharge switching device permanently transitions from the first state to the second state; and
discharging the battery cells through a voltage drain circuit only when the discharge switching device is in the second state.

17. The method of claim 16 wherein the activation device includes a battery management system included in the battery pack.

18. The method of claim 16 wherein the discharge switching device is a chemical fuse.

19. The method of claim 16 further comprising the step of visually indicating the discharge of the battery cells through the voltage drain circuit.

20. The method of claim 16 wherein the voltage drain circuit includes a power consuming load and a switching device, wherein the switching device provides a discharge path from the battery cells through the power consuming load when the discharge switching device is in the second state.
